(19) United States
(12) Patent Application Publication
(10) Pub. No.: US 2004/0037314 A1
(43) Pub. Date: Feb. 26, 2004

(54) Method and communication network for cross coding between codecs

(76) Inventor: Stephen L. Spear, Skokie, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/226,442

(22) Filed: Aug. 23, 2002

(51) Int. Cl. H04J 3/16

(52) U.S. Cl. 370/466; 370/469

(57) ABSTRACT

A method (400) and a communication network (210) for cross coding between encoded protocols in a communication system (100) are described herein. The communication system (100) provides communication services to a plurality of endpoints. In particular, the communication network (210) provides a cross coding element (330) coupled to receive a first encoded signal from a first endpoints (230) using a first encoded protocol. The communication network (210) converts the first encoded signal within the cross coding element (330) from the first encoded protocol to a second encoded protocol to produce a second encoded signal. The communication network (210) communicates the second encoded signal to a second endpoint (250) using the second encoded protocol.

### TECHNICAL FIELD

The present disclosure relates generally to communication networks, and more particularly, to a method and a communication network for cross coding between encoded protocols.

### BACKGROUND

Many wired communication networks are being transitioned from circuit to packet. A major change for transmission of voice and video is that the information is carried in packets and not as continuous streams of information. For a voice over Internet Protocol (VoIP) implementation of a communication network, an endpoint communicates via an access network to an Internet Protocol (IP) network. Typically, the IP network includes a call server to help set up the call, and a circuit gateway to connect any calls into the PSTN. For communication connected via the PSTN, the circuit gateway and the PSTN form the access network. The access network, for example, may be a cable network, a digital subscriber line (DSL) network, a satellite network, and a wireless or a wired local area network (LAN). Each access network may have a preferred method to encode the voice or video information streams as well as communication protocols specified to communicate with the access network.

Packets may include an encoding of a waveform or contain a collection of discrete samples of the encoding of the waveform. The encoding scheme is standardized to allow a decoding to reproduce the information. Voice codecs (coder/decoder, i.e., encoded protocol) are specified in different areas. The ITU G.7xx series of standards contain many types of codec standards, for example G.723 including VoIP codecs, G.722 including codecs that encode higher frequencies than the standard telephony PCM (a-law or mu-law), and G.729 specifying a family of 8 kbit codecs. GSM codec standards, i.e., full rate, half rate, enhanced full rate, and AMR, are in the GSM 6 series of standards. CDMA and TDMA standards come out of the American National Standards Institute (ANSI). For example, the original CDMA 8 k codec is IS96 and EVRC is IS127. Further, there are codecs that have not been taken to national or international standards bodies. The Integral Dispatch Enhanced Network (iDEN) has standardized 3 different codecs, which are referred to as I3, I6, and I12. Although these codecs are not publicly specified standards, detailed specifications associated with the I3, I6, and I12 codecs may be made available.

Current wireless communication systems may operate in accordance with different communication protocols such as a code division multiple access (CDMA) based communication protocol and a global system for mobile communications (GSM) protocol. In a mobile-to-mobile call, for example, a mobile station operating in accordance with a CDMA-based communication protocol may be in communication with a mobile station operating in accordance with a GSM-communication protocol. Typically, different voice codecs (i.e., coder/decoder that may be either an algorithm or a endpoint implementing the algorithm) are used for mobile-to-mobile traffic between the CDMA-based mobile station and the GSM-based mobile station.

For example, a CDMA-based mobile station may encode an analog voice signal, e.g., speech, with an enhanced variable rate codec (ERVC). When using EVRC, the mobile station encodes 20 milli-seconds (msec) of the analog voice signal into a packet. The mobile station transmits the encoded voice signal (i.e., the packets containing a description of the waveform during the 20 msec period) to a base station via an over-the-air channel. The base station routes the encoded voice signal to a BSC that contains or is operatively coupled to a CDMA system transcoder. The CDMA system transcoder converts the encoded voice signal into a pulse code modulation (PCM) signal used by a wireline communication network, e.g., PSTN. The PCM signal is a digital representation of the encoded voice signal where each byte represents an analog voltage of the analog voice signal. Further, the PCM signal is in a non-linear domain and it is routed through the communication network to the GSM system transcoder. The GSM system transcoder encodes the PCM signal with one of several possible GSM codecs (e.g., full rate (FR) codec, half rate (HR) codec, enhanced full rate (EFR) codec, and adaptive multi-rate (AMR) codec) for transmission to a GSM-based mobile station. Even though the CDMA and the GSM codecs may be operating at the same rate, e.g., 20 milli-second rate, the two codecs may not necessarily start at the same point. Thus, distortion may be introduced in the resulting voice signal at the GSM-base mobile station.

One aspect of designing a wireless communication system is to provide high quality voice and/or data transmission. As noted above, multiple transcoders may be used to accommodate mobile-to-mobile traffic between mobile stations operating in accordance with different communication protocols (e.g., a mobile-to-mobile call between a CDMA-based mobile station and a GSM-based mobile station). However, such use of multiple transcoders may reduce the quality of the voice signal from the mobile station because of the inherent non-linearity of voice codecs. In particular, the quality of the voice signal may deteriorate by converting the encoded voice signal to a non-linear pulse code modulation (PCM) signal. That is, the voice signal starts in the linear domain where it is sampled and compressed to go over the air in a low bit rate codec by a transcoder (i.e., an encoded voice signal). The encoded voice signal is recovered and again enters the non-linear domain when it is converted to the non-linear PCM signal, which in turn, is routed to another transcoder. The non-linear PCM signal is sampled and compressed into a new packet using a difference voice codec, which is sent over the air and converted back to the linear domain as the original voice signal. Further, additional information (e.g., information associated with synchronization and lost frames) may be lost or erroneously introduced during the conversion to non-linear PCM such that the quality of the mobile signal may be decreased. For example, a transcoder may encode a non-linear PCM signal including an artificial insertion to substitute for a lost frame. As a result, the quality of the voice signal may be deteriorated by encoding the artificial insertion. In addition, the post-filter process of a transcoder may also contribute to the distortion from conversion to non-linear PCM. Moreover, the codec framing used by the transcoders may not be synchronized (i.e., framing misalignment). Thus, the quality of the voice signal may further deteriorate by decoding the encoded voice signal without synchronization of the codec framing.

Therefore, a need exist to communicate between encoded protocols and to provide high quality transmission between endpoints.

### BRIEF DESCRIPTION OF THE DRAWINGS

This disclosure will be described in terms of several embodiments to illustrate its broad teachings. Reference is also made to the attached drawings.

FIG. 1 is a block diagram representation of a wireless communication system.

FIG. 2 is a block diagram representation of a mobile-to-mobile call.

FIG. 3 is a block diagram representation of a communication network.

FIG. 4 is a flow diagram illustrating a method for cross coding between encoded protocols.

### DETAILED DESCRIPTION

A method and a communication network for cross coding between encoded protocols (i.e., codecs) are described herein. The communication network provides a cross coding element coupled to receive a first encoded signal of a voice signal from a first endpoint using a first encoded protocol. In particular, the communication network may be, but is not limited to, an Internet Protocol (IP) network and an access network. The access network may be, but is not limited to, a cable network, a digital subscriber line (DSL) network, a satellite network, and a wireless or a wired local area network (LAN). In wireless communication networks, the access network includes a radio access network (RAN) and wireless core network. The first encoded protocol may be, but are not limited to, an enhanced variable rate codec (EVRC), a code excited linear prediction (CELP) codec, selective mode vocoder (SMV) codec, a full rate codec, a half rate codec, an enhanced full rate codec, and an adaptive multi-rate codec. The communication network conveys the first encoded signal to the cross coding element that converts the first encoded signal from the first encoded protocol to a second encoded protocol to produce a second encoded signal. For example, the cross coding element may convert the first encoded signal from a code division multiple access (CDMA) based communication protocol to a global system for mobile (GSM) communication protocol to produce the second encoded signal. The cross coding element may synchronize sampling periods of the first encoded protocol and a second encoded protocol to reduce distortion. The second encoded protocol may be, but is not limited to, an enhanced variable rate codec (EVRC), a code excited linear prediction (CELP) codec, selective mode vocoder (SMV) codec, a full rate codec, a half rate codec, an enhanced full rate codec, and an adaptive multi-rate codec. The cross coding element may reduce degradation in quality of the original voice signal by converting the first encoded signal within the cross coding element to a linear signal, and encode the linear signal with the second encoded protocol to produce the second encoded signal. The cross coding element communicates the second encoded signal to a second endpoint using the second encoded protocol. To further reduce degradation in quality of the original voice signal, the cross coding element may communicate information associated with a lost frame or packet to the second endpoint, or simply omit any information indicating that a lost frame or packet. That is, the second encoded signal may include information associated with a lost frame so that artificial insertions are not interpreted as voice. Further, the cross coding element may improve quality by eliminating the post-filter processing used a decoder associated with the first encoded protocol. The embodiments describe a wireless system with a large number of endpoints already deployed that use an encoded protocol for exchange of voice information.

A communication system is described herein in terms of several embodiments, and particularly, in terms of a wireless communication system operating in accordance with at least one of several standards. These standards include digital communication system protocols such as, but not limited to, the Global System for Mobile Communications (GSM), the IS-54 Time Division Multiple Access (TDMA) digital cellular system, the IS-134 TDMA digital cellular system, the IS-95 Code Division Multiple Access (CDMA) digital cellular system, CDMA 2000, the integrated Digital Enhanced Network (iDEN), the Personal Communications System (PCS), 3G, the Universal Mobile Telecommunications System (UMTS) and variations and evolutions of these protocols. The wireless communication system is a complex network of systems and elements. Typical systems and elements include (1) a radio link to mobile stations (e.g., a cellular telephone or a subscriber equipment used to access the wireless communication system), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a switching system, typically including a mobile switching center (MSC), to perform call processing within the system, and (5) a link to the land line, i.e., the public switch telephone network (PSTN) or the integrated services digital network (ISDN).

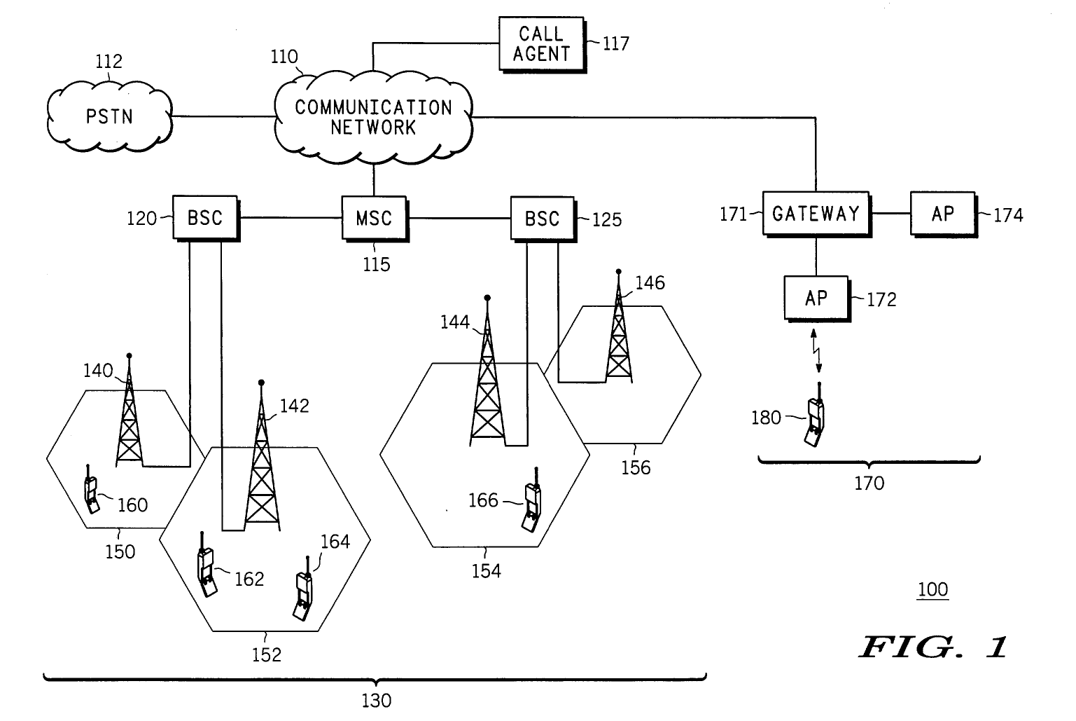

As shown in FIG. 1, a wireless communication system 100 includes a communication network 110 operatively coupled to the PSTN 112, and a switching system such as a call server (e.g., MSC 115) and a call agent 117. Alternatively, the PSTN 112, the MSC 115, and the call agent 117 may be integrated into the communication network 110. The communication system 100 also includes a plurality of base station controllers (BSC), generally shown as 120 and 125, servicing a total service area 130. As is known for such systems, each BSC 120 and 125 has associated therewith a plurality of base stations (BS), generally shown as 140, 142, 144, and 146, servicing communication cells, generally shown as 150, 152, 154, and 156, within the total service area 130. The BSCs 120 and 125, and base stations 140, 142, 144, and 146 are specified and operate in accordance with the applicable standard or standards for providing wireless communication services to mobile stations (MS), generally shown as 160, 162, 164, and 166, operating in communication cells 150, 152, 154, and 156, and each of these elements are commercially available from Motorola, Inc. of Schaumburg, Ill.

Although the embodiments disclosed herein are particularly well suited for use with wide area communication systems (i.e., cellular systems), persons of ordinary skill in the art will readily appreciate that the teachings herein are in now way limited to those systems. On the contrary, persons of ordinary skill in the art will readily appreciate that the teachings can be employed with other communication systems such as short-range wireless communication systems. For example, the communication network 110 may be operatively coupled to a wireless LAN (WLAN) 170 via a gateway 171 and access points, generally shown as 172, 174. The communication network 110 may operate in accordance with, but not limited to, a Bluetooth based communication protocol and an Institute of Electrical and Electronic Engineers (IEEE) 802.11 based communication protocol to provide wireless communication services to a mobile station 180 via the access points 172, 174.

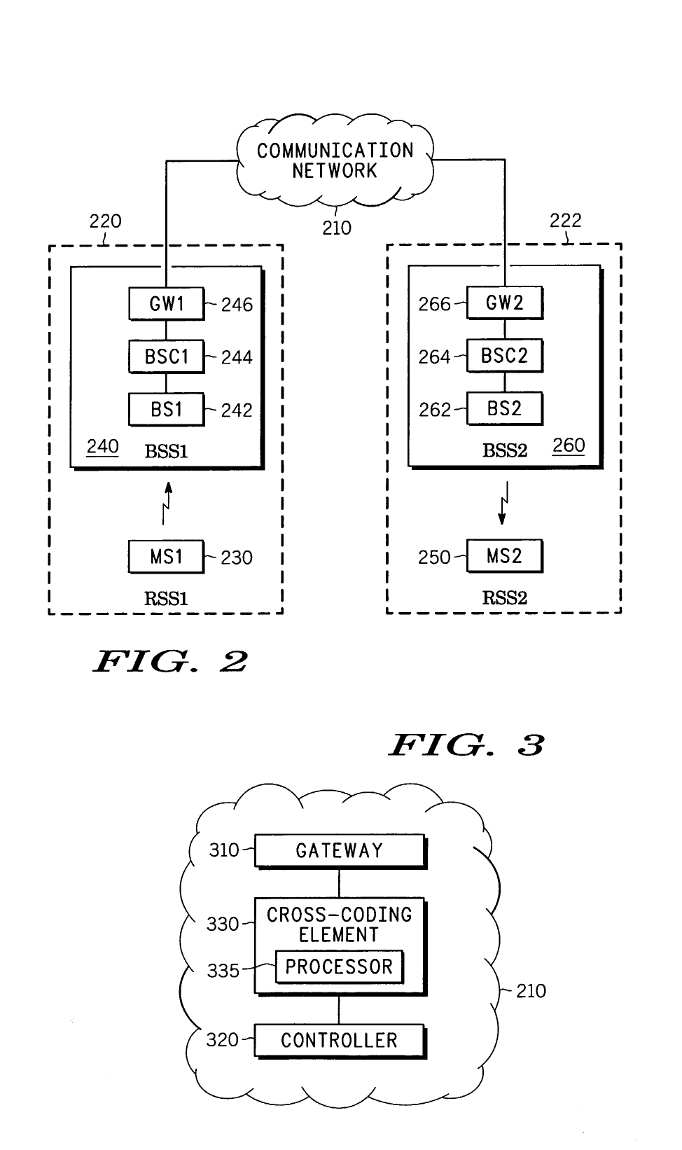

Referring to FIG. 2, a mobile-to-mobile call between a first subscriber and a second subscriber generally includes a communication network 210 operatively coupled to a first radio subsystem (RSS1) 220 and a second radio subsystem (RSS2) 222. The first radio subsystem 220 and the second radio subsystem 222 may be operable in accordance with, but are not limited to, a code division multiple access (CDMA) based communication protocol, a global system for mobile (GSM) based communication protocol, an integrated digital enhanced network (iDEN) based communication protocol, and a voice over Internet protocol (VoIP) based communication protocol. In particular, the first radio subsystem 220 generally includes a first mobile station (MS1) 230 and a first base station subsystem (BSS1) 240. Further, the first base station subsystem 240 includes, but is not limited to, a first base station (BS1) 242, a first base station controller (BSC1) 244, and a first gateway 246. Accordingly, the second radio subsystem 222 generally includes a second mobile station (MS2) 250 and a second base station subsystem (BSS2) 260, which includes a second base station (BS2) 262, a second base station controller (BSC2) 264, and a second gateway (GW2) 266.

A basic flow of a mobile-to-mobile call that may be applied with the communication network 210 shown in FIG. 2 may start with the first subscriber operating the first mobile station 230 (e.g., an endpoint) in the first radio subsystem 220 to initiate a call. For example, the first mobile station 230 receives a voice signal such as speech from the first subscriber. The first mobile station 230 encodes the voice signal with a first codec to produce a first encoded signal. In particular, the first codec is associated with the operating communication protocol of the first radio subsystem 220. For example, the first radio subsystem 220 may operate in accordance with a CDMA based communication protocol and the first codec may be an enhanced variable rate codec (ERVC). Accordingly, the first mobile station 230 transmits the first encoded signal via an over-the-air channel to the first base station 242 in the first base station subsystem 240. The first base station 242 routes the first encoded signal to the first base station controller 244, which in turn, routes the first encoded signal to the communication network 210 via the first gateway 246. Within the communication network 210, a cross coding element, which is further described below, converts the voice signal within the first encoded signal to produce a second encoded signal with the voice signal. The communication network 210 communicates the second encoded signal via the second gateway 266 to the second base station controller 264 in the second base station subsystem 260. Accordingly, the second base station controller 264 routes the second signal to the second base station 262, which in turn, transmits the second signal via an over-the-air channel to the second mobile station 250 in the second radio subsystem 222. The second mobile station 250 operates using a second codec, which is associated with the operating communication protocol of the second radio subsystem 222. For example, the second codec may be one of a full rate codec, a half rate codec, an enhanced full rate codec, and an adaptive multi-rate codec in response to the second radio subsystem 222 operating in accordance with a GSM protocol.

In today's CDMA and GSM systems, the BSC normally contains a transcoder, which translates between PCM and selected codec. For this disclosure, the transcoder in the RAN is bypassed. Transcoder bypass is a well established standard created to allow two endpoints that use the same codec to exchange information without incurring a degradation because of the dual encoding and decoding which would occur otherwise. Transcoder bypass includes tandem free operation in which the transcoder may operate but sends the encoded stream so as to appear to bypass the transcoder. In current CDMA and GSM systems, a cross coding element may negotiate transcoder bypass with the BSC to receive a signal from an endpoint.

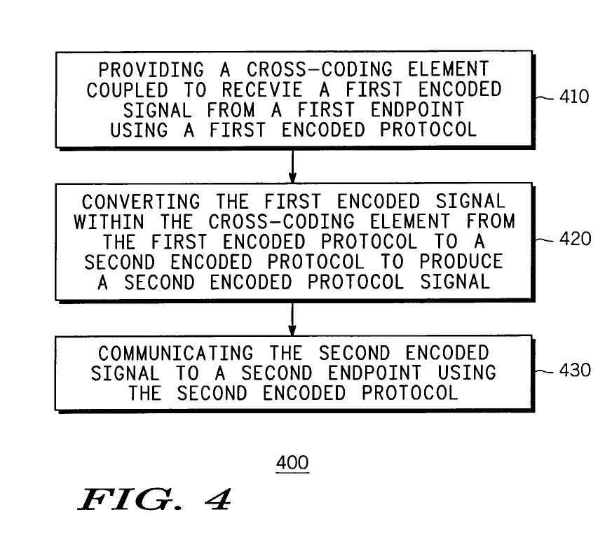

As shown in FIG. 3, the communication network 210 includes a gateway 310, a controller 320 and a cross coding element 330. The cross coding element 330 is operatively coupled to the gateway 310 and the controller 320. In particular, the cross coding element 330 may include a processor 335 that executes a program or a set of operating instructions such that the cross coding element 330 operates as described herein. The program or the set of operating instructions may be embodied in a computer-readable medium such as, but not limited to, paper, a programmable gate array, application specific integrated circuit, erasable programmable read only memory, read only memory, random access memory, magnetic media, and optical media.

A basic flow for cross coding a mobile signal that may be applied with the communication network 110 shown in FIG. 3 may start with the gateway 310 receiving a first encoded signal from a first mobile station (e.g., one shown in FIG. 2 as 230) using a first codec from a first radio subsystem. The first encoded signal may include, but is not limited to, a voice signal (e.g., speech) from a user of the first mobile station. The first codec may be, but is not limited to, an enhanced variable rate codec (EVRC), a code excited linear prediction (CELP) codec, selective mode vocoder (SMV) codec, a full rate codec, a half rate codec, an enhanced full rate codec, and an adaptive multi-rate codec. For example, a voice signal from a mobile station operating in accordance with a code division multiple access (CDMA) based communication protocol may be encoded with an ERVC (i.e., a 8 kb/s codec with 160 bits every 20 msec). In another example, a voice signal from a mobile station operating in accordance with a GSM protocol may be encoded with one of a full rate codec, a half rate codec, an enhanced full rate codec, and an adaptive multi-rate codec. The gateway 310 routes the first encoded signal to the cross coding element 330 to convert the first encoded signal, i.e., to produce a second encoded signal based on the voice signal within the first encoded signal. The second encoded signal is based on a second codec used by a second mobile station. The second codec may be, but is not limited to, an enhanced variable rate codec (EVRC), a code excited linear prediction (CELP) codec, selective mode vocoder (SMV) codec, a full rate codec, a half rate codec, an enhanced full rate codec, and an adaptive multi-rate codec. Because an endpoint (e.g., a mobile station) may move from one cell to another (e.g., from a first cell 150 to a second cell 152), from one wireless network to another (e.g., from a cellular network to a WLAN), and/or from one system to another (e.g., from a CDMA-based network to a GSM-based network or from a GSM-based network to an IP-based network), the cross coding element 330 may be configured to convert an encoded signal to different encoded protocols. For example, the cross coding element 330 may convert the voice signal with the first encoded signal to produce the second encoded signal based on a full rate codec in accordance with the GSM protocol. The cross coding element 330 may synchronize sampling periods of the first and second codecs to produce the second encoded signal to reduce distortion. To illustrate this concept, the cross coding element 330 may synchronize sampling periods of the EVRC and the full rate codec as mentioned above. The cross coding element 330 may also reduce degradation in quality of the original voice signal by converting the first encoded signal to a linear signal, and encode the linear signal with the second codec to produce the second encoded signal. Accordingly, the controller 320 communicates the second encoded signal via the gateway 310 to a second mobile station (e.g., one shown as 250 in FIG. 2) using the second codec. To further reduce degradation in quality of the original voice signal, the communication network may communicate information associated with a lost frame to the second mobile station. That is, the cross coding element 330 may include information associated with a lost frame in the second encoded signal so that artificial insertions are not interpreted as voice. The cross coding element 330 may further improve quality by eliminating the post-filter processing used a decoder associated with the first encoded protocol.

One possible implementation of the computer program executed by the cross coding element 310 is illustrated in FIG. 4. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 4, persons of ordinary skill in the art will appreciate that these steps can be performed in other temporal sequences. Again, the flow chart 400 is merely provided as an example of one way to program the cross coding element 310 to convert between codecs is shown. The flow chart 400 begins at step 410, wherein the cross coding element 310 may receive a first encoded signal (i.e., packets of a voice signal) from a first endpoint (e.g., a mobile station) using a first codec. The first endpoint is operating in accordance with a first communication protocol. Accordingly, the first codec is associated with the first communication protocol. For example, the first endpoint may operate in accordance with a CDMA based communication protocol. As a result, the first codec may be an EVRC. At step 420, the cross coding element 310 may convert the first encoded signal from a first encoded protocol to a second encoded protocol to produce a second encoded signal, which may be decoded by a second codec used by a second endpoint. The second endpoint is operating in accordance with a second communication protocol, and the second codec is associated with the second communication protocol. For example, the second codec may be a full rate codec if the second endpoint operates in accordance to a GSM communication protocol. To reduce distortion, the communication network may synchronize sampling periods of the first and second codecs within the cross coding element 310 to produce the second encoded signal. Further, the communication network may reduce degradation in quality of the original voice signal by converting the first encoded signal within the cross coding element 310 to a linear signal, and encoding the linear signal with the second codec to produce the second encoded signal. At step 430, the cross coding element 310 may communicate the second encoded signal to the second endpoint using the second codec. To further reduce degradation in quality of the original voice signal, the cross coding element 310 may communicate information associated with a lost frame to the second endpoint. That is, the second encoded signal may include information associated with a lost frame so that artificial insertions are not interpreted as voice.

Although the preferred embodiment uses voice codecs as an example, the cross coding element may be operable for video codecs and/or other information streams where a coding/decoding function occurs.

Many changes and modifications to the embodiments described herein could be made. The scope of some changes is discussed above. The scope of others will become apparent from the appended claims.

What is claimed:

1. In a communication system, a method for cross coding between encoded protocols, the method comprising:
providing a cross coding element coupled to receive a first encoded signal from a first endpoint using a first encoded protocol;
converting the first encoded signal within the cross coding element from the first encoded protocol to a second encoded protocol to produce a second encoded signal; and
communicating the second encoded signal to a second endpoint using the second encoded protocol.

2. The method of claim 1, wherein the step of providing a cross coding element coupled to receive a first encoded signal from a first endpoint using a first encoded protocol comprises providing a cross coding element within a communication network coupled to receive a first encoded signal from a first endpoint using a first encoded protocol.

3. The method of claim 1, wherein the step of providing a cross coding element coupled to receive a first encoded signal from a first endpoint using a first encoded protocol comprises providing a cross coding element within one of an Internet Protocol (IP) network, an asynchronous transfer mode (ATM) network, and a circuit network coupled to receive a first encoded signal from a first endpoint using a first encoded protocol.

4. The method of claim 1, wherein the step of coupled to receive a first encoded signal from a first endpoint using a first encoded protocol comprises providing a cross coding element operable to negotiate a transcoder bypass to receive a first encoded signal from a first endpoint using a first encoded protocol.

5. The method of claim 1, wherein the step of converting the first encoded signal within the cross coding element from a first encoded protocol to a second encoded protocol to produce a second encoded signal comprises synchronizing sampling periods of the first and second encoded protocols within the cross coding element to produce a second encoded signal.

6. The method of claim 1, wherein the step of converting the first encoded signal within the cross coding element from a first encoded protocol to a second encoded protocol to produce a second encoded signal comprises converting the first encoded signal within the cross coding element to a linear signal and encoding the linear signal with a second encoded protocol to produce the second encoded signal.

7. The method of claim 1, wherein the step of communicating the second encoded signal to a second endpoint using a second encoded protocol comprises communicating an encoded signal having information associated with a lost frame to a second endpoint using a second encoded protocol.

8. The method of claim 1, wherein the communication system operates in accordance with one of a code division multiple access (CDMA) based communication protocol, a global system for mobile (GSM) based communication protocol, an integrated digital enhanced network (iDEN) based communication protocol, and a voice over Internet protocol (VoIP) based communication protocol.

9. In a wireless communication system, the communication system providing communication services to a plurality of mobile stations, wherein a first mobile station is in a first communication system and a second mobile station is in a second communication system, a method for cross coding between encoded protocols, the method comprising:
providing a gateway between the first communication system and the second communication system;
providing a cross coding element operatively coupled to the gateway to receive a first encoded signal from the first communication system using a first encoded protocol;
converting the first encoded signal within the cross coding element from the first encoded protocol to a second encoded protocol to produce a second encoded signal; and
communicating the second encoded signal to the second communication system using the second encoded protocol.

10. The method of claim 9, wherein the step of providing a gateway between the first communication system and the second communication system comprises providing a gateway in each of the first communication system and the second communication system.

11. The method of claim 9, wherein the step of providing a gateway between the first communication system and the second communication system comprises providing a gateway within one of an Internet Protocol (IP) network, an asynchronous transfer mode (ATM) network, and a circuit network.

12. The method of claim 9, wherein the step of providing a cross coding element operatively coupled to the gateway to receive a first encoded signal from the first communication system using a first encoded protocol comprises providing a cross coding element within a communication network coupled to receive a first encoded signal from the first communication system using a first encoded protocol.

13. The method of claim 9, wherein the step of providing a cross coding element operatively coupled to the gateway to receive a first encoded signal from the first communication system using a first encoded protocol comprises providing a cross coding element operable to negotiate a transcoder bypass to receive a first encoded signal from a first endpoint using a first encoded protocol.

14. The method of claim 9, wherein the step of converting the first encoded signal within the cross coding element from a first encoded protocol to a second encoded protocol to produce a second encoded signal comprises synchronizing sampling periods of the first and second encoded protocols within the cross coding element to produce a second encoded signal.

15. The method of claim 9, wherein the step of converting the first encoded signal within the cross coding element from the first encoded protocol to a second encoded protocol to produce a second encoded signal comprises converting the first encoded signal within the cross coding element to a linear signal and encoding the linear signal with a second encoded protocol to produce the second encoded signal.

16. The method of claim 9, wherein the step of communicating the second encoded signal to a second mobile station using the second encoded protocol comprises communicating an encoded signal having information associated with a lost frame to a second mobile station using the second encoded protocol.

17. The method of claim 9, wherein each of the first and second communication systems operates in accordance with one of a code division multiple access (CDMA) based communication protocol, a global system for mobile (GSM) based communication protocol, an integrated digital enhanced network (iDEN) based communication protocol, and a voice over Internet protocol (VoIP) based communication protocol.

18. In a communication system, the communication system providing communication services to a plurality of endpoints, a communication network for cross coding a signal between encoded protocols, the communication network comprising:
a gateway;
a controller operatively coupled to the gateway; and
a cross coding element coupled to the controller, the cross coding element being operable to receive a first encoded signal from a first endpoint using a first encoded protocol,
the cross coding element being operable to convert the first encoded signal from a first encoded protocol to a second encoded protocol to produce a second encoded signal, and
the cross coding element being operable to communicate the second encoded signal to a second endpoint using the second encoded protocol.

19. The communication network of claim 18, wherein each of the first encoded protocol and second encoded protocol comprises one of an enhanced variable rate codec (EVRC), a code excited linear prediction (CELP) codec, a selective mode vocoder (SMV) codec, a full rate codec, a half rate codec, an enhanced full rate codec, an adaptive multi-rate (AMR) codec, a time division multiple access (TDMA) based codec, and a voice over Internet protocol (IP) based codec.

20. The communication network of claim 18, wherein the cross coding element comprises a cross coding element operable to synchronize sampling periods of the first and second encoded protocols to produce the second encoded signal.

21. The communication network of claim 18, wherein the cross coding element comprises a cross coding element operable to convert the first encoded signal to a linear signal and to encode the linear signal with a second encoded protocol to produce the second encoded signal.

22. The communication network of claim 18, wherein the cross coding element comprises a cross coding element operable to communicate an encoded signal having information associated with a lost frame to the second endpoint using the second encoded protocol.

23. The communication network of claim 18, wherein the cross coding element comprises a cross coding element operable to negotiate a transcoder bypass to receive a first encoded signal from a first endpoint using a first encoded protocol.

24. The communication network of claim 18, wherein the communication network comprises one of an Internet Protocol (IP) network, an asynchronous transfer mode (ATM) network, and a circuit network.

25. The communication network of claim 18, wherein the communication network is operable in accordance with a code division multiple access (CDMA) based communication protocol, a global system for mobile (GSM) based communication protocol, an integrated digital enhanced network (iDEN) based communication protocol, and a voice over internet protocol (VoIP) based communication protocol.

26. In a communication system, wherein a processor operates in accordance to a computer program embodied on a computer-readable medium for cross coding between encoded protocols, the computer program comprising:
a first routine that directs the processor to receive a first encoded signal within a cross coding element, the first encoded signal being from a first endpoint using a first encoded protocol;
a second routine that directs the processor to convert the first encoded signal within the cross coding element from the first encoded protocol to a second encoded protocol to produce a second encoded signal; and
a third routine that directs the processor to communicate the second encoded signal to a second endpoint using the second encoded protocol.

27. The computer program of claim 26, wherein the first routine comprises a routine that directs the processor to communicate with a cross coding element within a communication network to receive the first encoded signal, the communication network being one of an Internet Protocol (IP) network, an asynchronous transfer mode (ATM) network, and a circuit network.

28. The computer program of claim 26, wherein the first routine comprises a routine that directs the processor to negotiate a transcoder bypass within the cross coding element to receive the first encoded signal.

29. The computer program of claim 26, wherein the second routine comprises a routine that directs the processor to synchronize sampling periods of the first and second encoded protocols within the cross coding element.

30. The computer program of claim 26, wherein the second routine comprises a routine that directs the processor to convert the first encoded signal with the cross coding element to a linear signal and to encode the linear signal with a second encoded protocol to produce the second encoded signal.

31. The computer program of claim 26, wherein the third routine comprises a routine that directs the processor to communicate an encoded signal having information associated with a lost frame to a second endpoint using the second encoded protocol.

32. The computer program of claim 26 operates in accordance with one of a code division multiple access (CDMA) based communication protocol, a global system for mobile (GSM) based communication protocol, an integrated digital enhanced network (iDEN) based communication protocol, and a voice over Internet protocol (VoIP) based communication protocol.

33. The computer program of claim 26, wherein the medium comprises one of paper, a programmable gate array, application specific integrated circuit, erasable programmable read only memory, read only memory, random access memory, magnetic media, and optical media.
